(19) United States
(12) Patent Application Publication
(10) Pub. No.: US 2009/0022946 A1
(43) Pub. Date: Jan. 22, 2009

(54) Membrane Structure and Method for Manufacturing the Same

(75) Inventors: Masato Hayashi, Hyogo (JP); Msanori Yamaguchi, Hyogo (JP); Yohei Yamada, Hyogo (JP); Jun Murase, Hyogo (JP); Katsuyuki Ono, Hyogo (JP); Naoyuki Satoh, Yamanashi (JP)

Correspondence Address: MASUVALLEY & PARTNERS, 8765 AERO DRIVE, SUITE 312, SAN DIEGO, CA, 92123, US

(73) Assignee: TOKYO ELECTRON LIMITED, TOKYO (JP)

(21) Appl. No.: 12/223,765

(22) PCT Filed: Feb. 8, 2007
(86) PCT No.: PCT/JP2007/052279

§ 371 Date: Aug. 8, 2008

(30) Foreign Application Priority Data
Feb. 10, 2006 (JP) 2006-034267

(51) Int. Cl. B32B 7/00; B44C 1/22

(52) U.S. Cl. 428/119; 216/41

(57) ABSTRACT

The present invention provides a membrane structure having favorable pressure resistance and a manufacturing method of the same. After forming an opening (21a) on a substrate (21) by Deep Digging Reactive Ion Etching (DRIE), vertical streak formed by DRIE on the side face (inner peripheral face) of the opening (21a) is removed by performing light etching with an alkali etchant. The level of overhang of an overhanging section (21b) formed when forming an opening (22a) of a BOX layer (22) is suppressed by suppressing the overetching level when forming the BOX layer (22) by etching.

### TECHNICAL FIELD

The present invention relates to a membrane structure having a thin film and a method for manufacturing the same.

### BACKGROUND OF THE INVENTION

Conventionally, a membrane structure is provided with a substrate and a thin film formed so as to cover an opening provided onto the substrate. And the membrane structure is used in various technical fields, such as an electron beam transmission window in an electron beam irradiation apparatus, pressure sensor and sound sensor.

For example, in a case when the membrane structure is used in an electron beam irradiation apparatus, the electron beam irradiation apparatus is equipped with an electron beam generating source in a vacuum container, and a membrane structure is provided in an area of the vacuum container where an electron beam exits (for example, refer to Japanese Unexamined Published Patent Application No. 2005-265437). And the electron beam generated from the electron beam generating source passes through a thin film provided to the membrane structure and is irradiated to an object to be treated provided in the atmosphere or in a reduced pressure environment. In addition, the electron beam (EB) irradiation apparatus is used for chemically treating and modifying resin, chemically treating photoresist and interlayer insulators, sterilizing and so on.

By the way, the membrane structure is formed from a substrate provided with an opening and a thin film provided onto the substrate so as to cover the opening as described above. For example, in a case when the membrane structure is provided to an electron beam irradiation tube, the substrate is positioned to face inside, the inside of the irradiation tube is generally configured in a vacuum state, and the outside is configured to the atmosphere or in a reduced pressure state. For this reason, the thin film in the membrane structure bends towards the inside the irradiation tube, that is, the substrate side, due to the difference in pressure. In such a case, when a projection or the like is formed on a side face of the opening provided to the substrate, the thin film may contact the projection when it bends towards the substrate side or may be damaged due to a concentration of stress, thus there is a problem in reducing the strength of the membrane structure. Further, the strength of the thin film gradually decreases by repeatedly contacting the projection, which may result in a reduction of the membrane structure life.

Similarly, in a case when the membrane structure is used as a pressure sensor or sound sensor, there also are problems of strength and life of the membrane structure because of contact to a projection or damage to the thin film due to the concentration of stress when the projection and the like is formed on the opening.

The present invention has been made considering the above situation, and the objective is to provide a membrane structure having favorable strength and life and a manufacturing method of the same.

### SUMMARY OF THE INVENTION

In order to achieve the above objective, a membrane structure pertaining to an aspect of the present invention includes a first layer having a first opening and a second layer formed on one of the principal faces of the first layer so as to cover the first opening, wherein a side face on the first opening of the first layer is formed virtually vertical relative to the principal face of the first layer and a specific crystal face appears on an end on the second layer side of the first opening.

According to the present invention, a membrane structure having a favorable strength and life and a manufacturing method of the same can be provided by smoothing a side face (inner peripheral face) of an opening by applying wet etching after providing the opening to a substrate by applying dry etching.

### BRIEF DESCRIPTION OF THE DRAWINGS

FIG. 1 illustrates a membrane structure pertaining to the present invention. FIG. 1(a) is a plane view and FIG. 1(b) is an A-A cross section of FIG. 1(a).

FIG. 2 is an enlarged view illustrating an overhanging section of a silicon substrate.

FIG. 3 is a figure illustrating a case that a membrane structure pertaining to the present invention is provided in an electron beam irradiation tube.

FIG. 4 A is a cross sectional view of a substrate used in a membrane structure pertaining to the example of the present invention.

FIG. 4B is a cross sectional view of a substrate on which a protection film is formed.

FIG. 4C is a cross sectional view of a substrate in which an opening is formed on the protection film.

FIG. 4D is a cross sectional view of a substrate in which an opening is formed on a silicon substrate.

FIG. 4E is a cross sectional view of a substrate in which a resist pattern is removed.

FIG. 4F is a cross sectional view of a membrane structure in which an opening is formed on a box layer.

FIG. 5 illustrates a result on an experiment of pressure resistance of a membrane structure pertaining to the present invention.

### EXPLANATION OF SYMBOLS

### 10 MEMBRANE STRUCTURE

### 11 SUBSTRATE

### 12 THIN FILM

### 21 SILICON SUBSTRATE (FIRST LAYER)

### 21a OPENING (FIRST OPENING)

### 21b OVERHANGING SECTION

### 22 BOX LAYER (THIRD LAYER)

### 22a OPENING (SECOND OPENING)

### 31 SILICON ACTIVE LAYER (SECOND LAYER)

### DETAILED DESCRIPTION OF INVENTION

A membrane structure and a manufacturing method of the same pertaining to the present invention will be explained using figures. The membrane structure is used in a pressure sensor, sound sensor and electron beam transmission window of an electron beam irradiation apparatus. Especially in this example, in a case of using the membrane structure as an electron transmission window of an electron beam irradiation tube provided in an electron beam irradiation apparatus is explained. The electron beam irradiation apparatus is generally used for curing (chemically treating) and modifying resin, curing photoresist and interlayer insulators, sterilizing and so on.

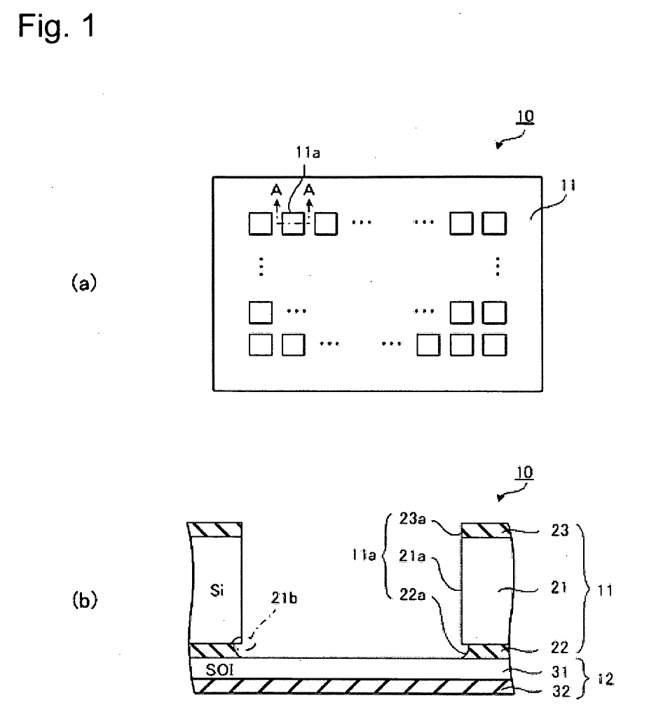

A membrane structure 10 pertaining to the example of the present invention is illustrated in FIGS. 1(a) and 1(b). FIG. 1(a) is a plane view of the membrane structure 10, and FIG. 1(b) is an A-A cross sectional view of FIG. 1(a).

The membrane structure 10 pertaining to the example of the present invention is provided to an electron beam (EB) irradiation tube 40 of an electron beam (EB) irradiation apparatus (not shown). For example, the EB irradiation tube 40 has a tubular section 40a where an electron beam generating source is provided, and a flat plate section 40b, which is a face where electron beam is discharged. And, in the membrane structure 10, a substrate 11 shown in FIG. 1(b) is provided so as to contact the flat plate section 40b of the EB irradiation tube 40. The electron beam generated in the electron beam generating source is irradiated externally passing through a thin film 12 through an opening 11a provided to the substrate 11.

Inside of the EB irradiation tube 40 is maintained in a high vacuum state, for example, about 1.3×10⁻⁷˜10⁻¹⁰ Pa(1×10⁻⁹˜10⁻¹²Torr). The outside of the EB irradiation tube 40 is in an atmospheric pressure or reduced pressure state, and may change in a range of, for example, about 1.3×10⁻⁴PA(1×10⁻⁶Torr)˜atmospheric pressure. By this difference in pressure of inside and outside of the EB irradiation tube, the thin film 12 of the membrane structure 10 bends towards the substrate 11 direction.

The membrane structure 10 is formed from the substrate 11 and the thin film 12 as shown in FIGS. 1(a) and 1(b).

The substrate 11 has a silicon substrate 21, a BOX layer 22, and a protection film 23, and formed in a virtually square flat plate. Further, the substrate 11 is provided with a plurality of openings 11a arranged in a matrix. The openings 11a include an opening 21a of the silicon substrate 21, an opening 22a of the BOX layer 22 and an opening 23a of the protection film 23. The plane form of the openings 11a is formed in a virtual square as shown in figure 1(a). And, the side face of the opening 11a is virtually vertical relative to the principal face of the substrate 11, and the cross sectional shape is also formed in a virtual square as shown in FIG. 1(b). In this way, since the cross sectional shape of the opening 11a is in a virtual square (waistless shape), it is efficient that a plurality of openings 11a can be closely arranged in a limited area of the substrate 11.

Further, unlike a case, for example, when the cross sectional shape is formed in a trapezoidal shape narrow in film direction, the area of thin film 12 exposed through the opening 11a can be wider by configuring the cross sectional shape of the opening 11a in a virtual square. In other word, the area of the substrate 11 can be small when attempting to obtain a certain total area of the thin film 12 exposed through the opening 11a, thus the number of membrane structures 10 manufactured from a wafer with limited area increases, thereby increase in manufacturing efficiency and a reduction in manufacturing cost can be realized.

The silicon substrate 21 is formed from a silicon single-crystal substrate, and provided with the opening 21a and an overhanging section 21b. For example, a silicon single-crystal substrate of crystal plane orientation (100) is used for the silicon substrate 21 in this example. Further, the silicon substrate 21 has a thickness of, for example, about 100-1000 μm. As described later, the openings 21a are formed by Deep Reactive Ion Etching (DRIE). Vertical streaks form on the side face of the openings 21a by DRIE (irregularity in a streak form occurs in dry etching direction) are removed by light etching with an alkali etchant and formed smoothly.

In this way, because the opening 21a of the silicon substrate 21 is formed smoothly and no projection is formed, the damage to the thin film 12 due to contact to the projection or concentration of stress can favorably be prevented in a case where the thin film 12 is bended towards the silicon substrate 21 when the differential pressure of high vacuum and atmospheric pressure or larger than the differential pressure is applied to the membrane structure 10.

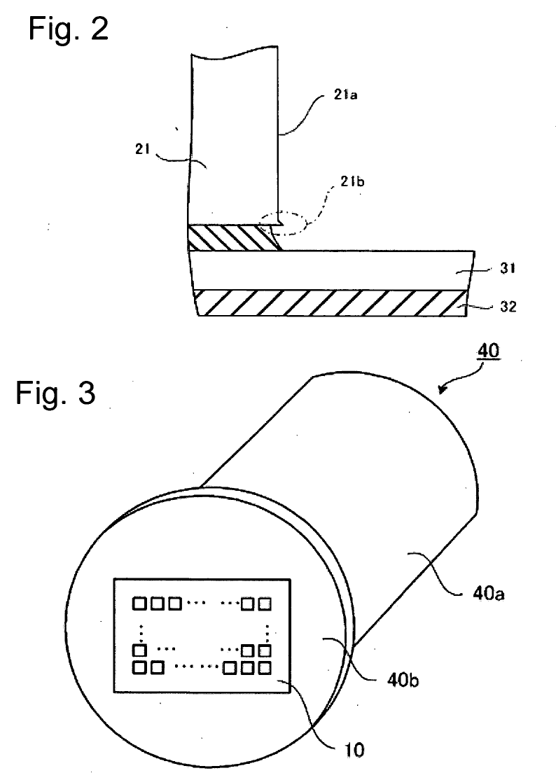

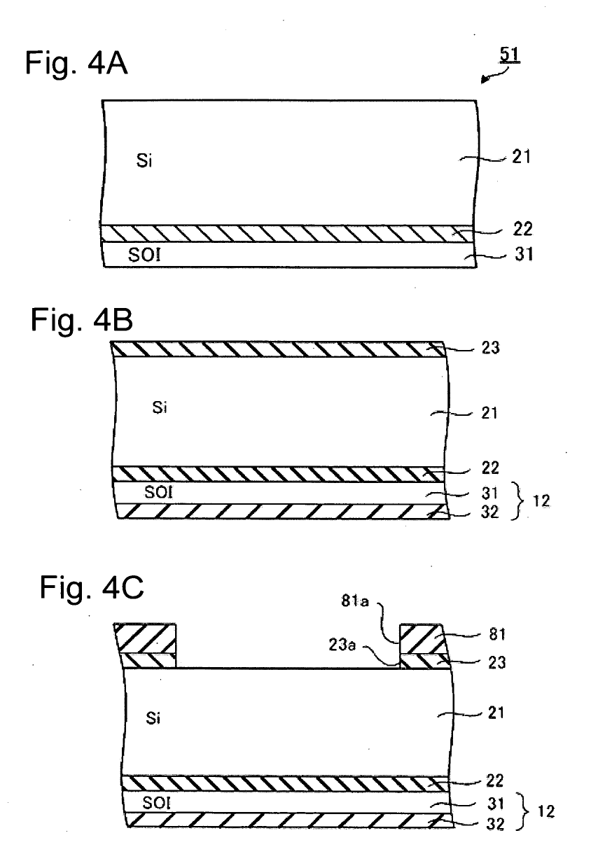

Further, as shown in FIG. 1(b), the overhanging section 21b is formed on a boundary face of the silicon substrate 21 and the BOX layer 22 along the circumference of the opening 11a in an overhang over the thin film 12. The overhanging section 21b may be formed in a taper form in an acute angle protruding in the opening side as shown in FIG. 2, an enlarged view of a cross-section shape. As discussed in detail later, the overhanging section 21b is created because the side face of the opening 22a of the BOX layer 22 sets back from the opening 21a of the silicon substrate (the etching on the opening 22a progresses from the opening 21a) when the opening 22a of the BOX 22 is formed.

When smoothing the inner peripheral face of the opening 21a of the silicon substrate 21, although etching progresses to the (110) crystal face direction but it does not progress to the (111) crystal face side, thus a (111) crystal face appears on an end of the opening 21a of the silicon substrate 21. As a result, the overhanging section 21b has a 55 degree angle relative to a principal surface (horizontal line shown in FIG. 2) of the silicon substrate 21.

As described in detail later, by suppressing the amount of over etching at the etching of the BOX layer 22 or using the anisotropic etching, such as dry etching, the amount of setback of the opening 22a of the BOX layer 22 relative to the opening 21a of the silicon substrate 21 at the boundary face of the silicone substrate 21 and the BOX layer 22 can be reduced down to preferably almost the same as the film thickness or smaller than the film thickness. In other words, the amount of overhang of the overhanging section 21b can be suppressed.

The irregularity on the side face of the opening 21a can be eliminated by applying light etching to the side face of the opening 11a after forming the opening 11a by dry etching. Further, the amount of overhang of the overhanging section 21b can be suppressed by adjusting the conditions when applying the etching to the BOX layer 22. Therefore, the thin film 12 is provided with a favorable strength without contacting the overhanging section 21 or the concentration of stress even when the bend of the thin film 12 is increased by configuring the pressure outside of the membrane structure 10 to atmospheric pressure or above.

The BOX (Buried Oxide) layer 22 is formed from a silicon dioxide film. Further, the BOX layer 22 is formed between a silicon active layer 31 and the silicon substrate 21 that forms the thin film 12. The BOX layer 22 has a thickness of, for example, about 0.1 to 5 μm. The BOX layer 22 has an opening 22a that an opening face is formed concentric to the opening 21a of the silicon substrate 21. The BOX layer 22 functions as an etching stopper film for forming the opening 21a of the silicon substrate 21 by dry etching. The opening 22a of the BOX layer 22 is formed through the opening 21a, for example, by performing etching with hydrofluoric acid (HF) solution or the like after forming the opening 21a on the silicon substrate 21. For this reason, the side face of the opening 22a is set back from the opening 21a of the silicon substrate 21 as shown in FIG. 1(b), in other words, the side face of the opening 21a is protruded from the side face of the opening 22a, thereby the overhanging section 21b is created.

The protection film 23 is formed from, for example, Si₃N₄ film and formed over the upper surface of the silicon substrate 21 (the surface facing to the surface that the thin film 12 is formed) as shown in FIG. 1(b). Further, the protection film 23 has an opening 23a which is formed in virtually the same shape overlapping the opening 21a. The protection film 23 has a thickness of about 0.05 μm to 5 μm.

The thin film 12 is formed from a silicon active layer 31 and a protection film 32. The thin film 12 is formed to cover the lower principal face of the substrate 11, and an electron beam passes through the area overlapping with the opening 11a of the substrates 11. Therefore, the thin film 12 is formed thin enough for the electron beam to pass through.

The silicon active layer 31 forms a SOI (Silicon On Insulation) substrate. The silicon active layer 31 is formed between the BOX layer 22 and the protective layer 32. The silicon active layer 31 has a thickness of about 0.1 μm to 10 μm.

The protection film 32 is for example, formed from Si₃N₄ film and formed on a lower face of the silicon active layer 31 as shown in FIG. 1(b) to protect the surface of the silicon active layer 31. As described later, the protection film 32 is formed simultaneously with the protection film 23 and having the same thickness with the protection film 23, concretely about 0.05 μm to 5 μm.

In the membrane structure 10 of the example, the irregularity on the inner peripheral face of the opening 21a formed at the dry etch is removed and smoothed by applying light etching on the side face of the opening 21a after forming the opening 21a on the silicon substrate 21 by dry etching. For this reason, the damage to the thin film 12 can be favorably prevented even in a case when the thin film 12 is bent to the substrate 11 direction due to a pressure difference.

Amount of setback of the side face of the opening 22a from the side face of the opening 21a is suppressed by suppressing the amount of over etching in forming the opening 22a on the BOX layer 22. Therefore, the thin film 12 does not contact the overhanging section 21b even when the thin film 12 is bent, thus the damage to the thin film 12 due to concentration of stress can favorably be prevented.

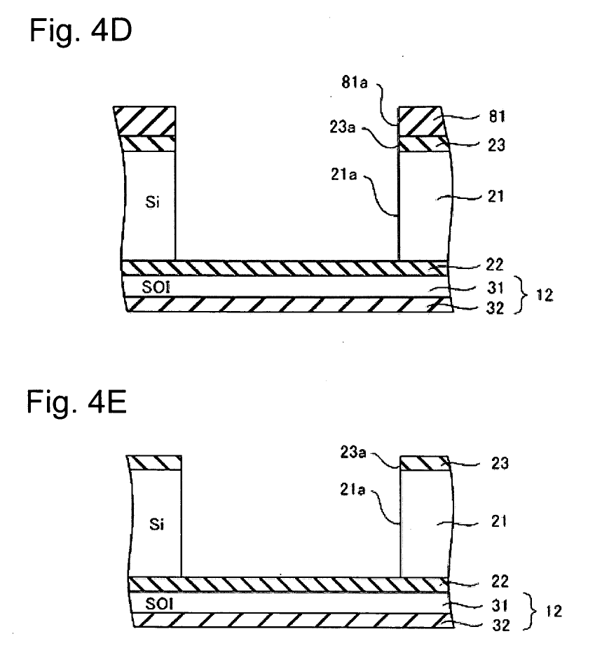

Next, a manufacturing method of the membrane structure pertaining to the present invention is hereinafter explained with reference to drawings. FIGS. 4A to 4F illustrate the manufacturing method.

First, prepare a substrate 51 as shown in FIG. 4A. The substrate 51 is a so called SOI (Silicon On Insulation) substrate and a silicon active layer 31, the BOX (Buried Oxide film) layer 22 and silicon substrate 21 are stacked. For example, a silicon single crystal substrate of a crystal plane orientation (100) is used as the silicon substrate 21. Further, in the example, the substrate 51 has an area which is capable of forming a plurality of membrane structures 10 simultaneously.

FIG. 4B is a cross section diagram of the substrate 51 in which a protection film is formed on the surface. A Si₃N₄ film is formed on upper and lower surfaces of the substrate 51 by LP-CVD (Low Pressure Chemical Vapor Deposition). In this way, a protection film 23 is formed on the upper face of the substrate 51, and a protection film 32 is formed on the lower face of the substrate 51 as shown in FIG. 4B.

FIG. 4C is a cross section diagram of the substrate 51 in which an opening 23a is formed on the protection film 23. To form the opening 11a, first, fix the substrate 51 to a supporting substrate (not shown) by applying a temporary joint material, such as a wax or grease, on the surface of the protection film 32. Next, form a resist pattern 81 provided with an opening 81a, which is corresponding to an area formed with an opening 21a, on the upper face of the protection film 23 (the upper face shown in FIG. 4B), by photolithography or the like. Then, the opening 23a is formed on the protection film 23 by etching using the resist pattern 81 as a mask.

FIG. 4D is a cross sectional diagram of the substrate 51, in which an opening 21a is formed on the silicon substrate 21. The opening 21a is formed by etching the silicon substrate 21 with the Deep Reactive Ion Etching (DRIE) through the opening 81a of the resist pattern 81 and the opening 23a of the protection film 23. The opening 21a passes through the silicon substrate 21 and reaches to the thin film 12. In such a case, the BOX layer 22 functions as an etching stopper film. At this point, the side face of the opening 21a is formed virtually vertical, and a schematic (110) crystal face is exposed. Further, the side face of the opening 21a has longitudinal streaks on the silicon substrate 21 (along the etching direction) due to an effect of the DRIE.

As shown in FIG. 4E, remove the resist pattern 81. Then, remove the temporary joint material, such as wax or grease, between the protection film 32 and the supporting substrate (not shown). And, the substrate is diced into a chip unit while the protection film 32 and the supporting substrate are detached.

FIG. 4F is a cross sectional diagram of the membrane structure 10 in which an opening section 22a is formed on the BOX layer 22. Dip the opening 21a in an alkali etchant or an organic solvent in which mixing the alkali etchant to remove the vertical streaks formed on the side face (inner peripheral face) of the opening 21a at the dry etching. As the alkali etchant, for example, potassium. hydroxide (KOH), tetramethylammonium hydroxide (TMAH), hydrazine (N₂H₄), ethylenediamine pyrocatechol (EDP), sodium hydroxide (NaOH) and the like, or a mixture of one of these into alcohol solvent is used. Further, as the organic solvent, isopropyl alcohol (IPA) and the like is used. In such a case, the etching progresses to the (110) crystal face direction of the silicon substrate 21, but it does not progress to the (111) crystal face direction, thus, (111) crystal face is exposed on an end of the thin film 12 side of the opening 21a, that is the face contacting the BOX layer 22 and formed in a taper shape having about a 55 degree angle relative to the principal surface (horizontal face of FIG. 2) of the silicon substrate 21.

Next, remove the BOX layer 22 exposing through the opening 21a using a HF solution. In this way, an opening 22a of the BOX layer 22 is formed as shown in FIG. 4F. At this time, the etching reaches the boundary face of the silicon substrate 21 proximate to the opening 21a and the BOX layer 22, and the side etching is applied to the side face (inner peripheral face) of the opening 22a, thereby the overhanging section 21b is created. In the example, especially in this process, the amount of over etching is adjusted to decrease the amount of setback of the opening 22a of the BOX layer 22 relative to the opening 21a of the silicon substrate 21 preferably down to about the same as the film thickness of the BOX layer 22.

The membrane structure 10 is manufactured in the process described above.

In the manufacturing method of the membrane structure 10 of the example, the vertical streaks created on the inner peripheral face of the opening 21a can be removed and smoothed by applying light etching on the inner peripheral face of the opening 21a using an alkali etchant, such as KOH, after forming the opening 21a on the silicon substrate 21 by DRIE. Therefore, even when the thin film 12 bends towards the substrate 11 direction by the difference in pressure, contact of the thin film 12 to a projection or concentration of stress can be suppressed because the projection is not formed in the opening 21a of the silicon substrate 21, thereby damage to the thin film 12 can be favorably prevented.

The amount of overhang of the overhanging section 21b can be suppressed by suppressing the amount of over etching when forming the opening 22a on the BOX layer 22. Therefore, even when the thin film 12 is bended by the difference in pressure, the damage to the thin film 12 can further be prevented favorably because the amount of overhang of the overhanging section 21b is suppressed.

The opening 21a with a virtually vertical side face can be formed, for example, only by wet etching. However, there is a problem of an increase in manufacturing cost because the necessity of devising, such as using a substrate with a special crystal orientation, as well as a problem of losing the freedom in processing configuration. On the contrary, the manufacturing method of the membrane structure 10 of the example, the side face is smoothed by wet etching after forming the opening 21a with a virtually vertical side face by dry etching. For this reason, the opening 21a in a vertical shape with a smooth surface can be provided using a generally inexpensive substrate.

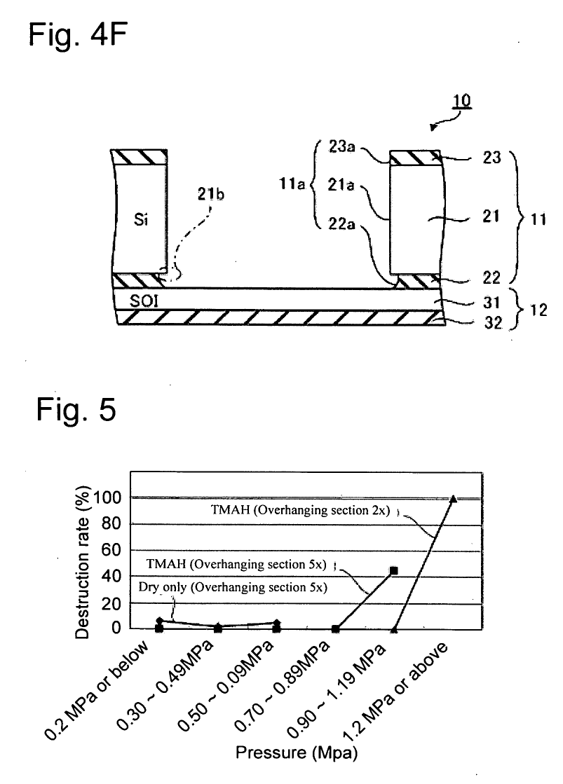

FIG. 5 illustrates an experiment result of pressure test for the membrane structure 10 provided with a plurality of openings 11a manufactured by the manufacturing method described above. The experiment is performed by a method that gradually increases atmospheric pressure on the thin film 12 side while maintaining the atmospheric pressure on the substrate 11 side, and stops applying pressure when the thin film is destroyed. Then, a destruction ratio is calculated by counting the number of the positions where the thin film is destroyed.

First is a case of a membrane structure where the amount of setback of the BOX layer by the side etching is about five times the film thickness of the BOX layer by removing the BOX layer through the opening of the silicone substrate without applying wet etching after forming the opening on the silicon substrate by dry etching or without optimizing the etching conditions (dry only shown in FIG. 5 (5× of overhanging section). With this membrane structure, the thin film is destroyed at 5% of positions at 0.29 MPa or below. Similarly, the thin film is destroyed at 5% of positions at 0.30 to 0.49 MPa and 0.50 to 0.69 MPa. In addition, it is obvious that the thin film will be destroyed in a ratio of 5% or more at the pressure of 0.70 MPa or above, thus the experiment is not performed at 1.2 MPa or above.

Second is a case of a membrane structure where the amount of setback of the BOX layer by side etching is about five times the thickness of the BOX layer by performing wet etching with TMAH after forming the opening on the silicon substrate by dry etching, and the BOX layer is removed through the opening of the silicon substrate without optimizing the etching conditions (TMAH (5X of overhanging section) shown in FIG. 5). In this membrane structure, there is no destruction up to 0.89 MPa, but the thin film is destructed at about 45% of positions when the pressure exceeds 0.90 MPa. In addition, it is obvious that destruction will occur at the pressure of 1.2 MPa or above, thus the experiment is not performed at 1.2 MPa or above.

Third is a case of a membrane structure where the amount of setback of the BOX layer by side etching is about a little over twice the thickness of the BOX layer by performing wet etching with TMAH after forming the opening on the silicon substrate by dry etching, and the BOX layer is removed through the opening of the silicon substrate while optimizing the etching conditions so as to decrease the amount of the setback of the opening of the BOX layer (TMAH (2X of overhanging section) shown in FIG. 5). In this membrane structure, the resistance to pressure is significantly increased compared to the cases of not optimizing the etching conditions, and provided a result in which the thin film is not destroyed up to 1.19 MPa.

Comparing the dry only (X5 of overhanging section) and TMAH (X5 of overhanging section) in FIG. 5 in this way, it is apparent that the resistance to pressure is significantly increased by removing the vertical streaks on the side face of the opening created at the dry etching. Further, comparing the TMAH (X5 overhanging section) and TMAH (X2 of overhanging section), it is apparent that the resistance to pressure significantly increases by suppressing the amount of over etching of the BOX layer while optimizing the etching conditions. Based on the above result, the resistance to pressure of the membrane structure is significantly improved by applying the wet etching after dry etching. In addition, it can be said that the resistance to pressure of the membrane structure is further improved by suppressing the amount of side etching when removing of the BOX layer.

The present invention is not limited to the examples described above and various modifications and applications can be made. For example, in the examples described above a case of manufacturing the membrane structure used in the electron beam transmission window of the electron beam irradiation apparatuses discussed as an example. However, the manufacturing method of the example can be applied to a membrane structure used in a pressure sensor using a modification of thin film, sound sensor and separation membrane of a specific substance.

In the examples described above, the membrane structure is formed by forming the openings on the silicon substrate and BOX layer using the SOI substrate having a silicon substrate, BOX layer and silicon active layer. However, it is not limited to the above and substrates other than the SOI substrate can be used to manufacture an arbitrary membrane structure. For example, oxide film, nitride film, carbide film (SiC), and metal film, such as Ti or nickel, or a laminated film of those arbitrary materials may be formed on the silicon substrate. At that time, the opening is formed by applying dry etching and wet etching to the silicon substrate and oxide film, nitride film or carbide film (SiC), a metal film such as Ti or nickel and a laminated film of those arbitrary materials can remain as a thin film. The layer to form the opening and the configuration of the layer that remains as a thin film can be changed as needed depending of the usage on the membrane structure and various changes can also be made to the manufacturing method for the membrane structure.

In the examples described above, explained as an example is a case where the silicon single crystal substrate of crystal face orientation (100) is used as the silicon substrate, the crystal face appears on the side face of the opening (vertical face) is (110)-face, and the crystal face appears on the overhanging section is (111)-face. The crystal face orientation of the silicon substrate is not limited to the examples described above. For example, using a silicon single crystal substrate of a crystal face orientation (100) and the crystal face appearing of the side face of the opening is (100)-face and the crystal face appearing on the overhanging section may be (110)-face (in such a case, the angle of overhanging section is about 45 degree). Further, using a silicon single crystal substrate of crystal face orientation (110), the crystal face appearing on the side face of the opening is (111)-face and the crystal face appearing on the overhanging section may be (111)-face (in such a case, the angle of overhanging section is about 90 degree). Still further, using a silicon single crystal substrate of a crystal face orientation (111), the crystal face appearing on the side face of the opening is (110) face and the crystal face appearing on the overhanging section may be (110)-face (in such a case, the angle of the overhanging section is about 90 degree).

Further, the method for forming the opening 22a of the BOX layer 22 is not limited to the forming method by the wet etching using the HF solution as described above. For example, solutions other than the HF solution may be used, or the opening 22a of the BOX layer 22 may be formed by an anisotropic etching, such as dry etching. Especially when the anisotropic etching, such as dry etching, is used, the setback amount of the BOX layer 22 can be smaller than the film thickness of the BOX layer.

In addition, the protection films 23 and 32 are not limited to Si₃N₄ film, and SiO₂, SiC, BN, B₄C, Al₄C₃ and the like may be used, or these materials may be used by arbitrarily combining them. Further, the protection films 23 and 32 can also be omitted.

It should be understood that the examples disclosed herein are only exemplary in all aspects and should not be considered as limitations. The scope of the present invention is indicated by the scope of claims, and intended to include equal meaning of the scope of claims and all changes within the scope of claims.

This application is based on Japanese Patent application No. 2006-34267, filed on Feb. 10, 2006. The specification, claims, and drawings of the Japanese patent application No. 2006-34267 are incorporated herein by reference in its entirety.

What is claimed is:

1. A membrane structure comprising;
a first layer having a first opening;
a second layer formed on one of principal faces of the first layer so as to cover the first opening;
a third layer between the first and second lavers having an opening concentric to the first opening;
wherein a side face of the first opening of the first layer is formed in virtually vertical relative to the one of principal faces of the first layer;
a specific crystal face appears on an end on the second layer side of the first opening;
an amount of setback of the opening of the third layer from the first opening of the first layer at a boundary face of the first layer and the third layer is about the same as the film thickness of the third layer or smaller than the film thickness and lager than 0; and
a predetermined deflection is provided proximity to the opening depending on the difference in pressure applied to one principal face and another principal face.

2. (canceled)

3. The membrane structure according to claim 1, wherein the first layer comprising a silicon substrate having a (100) crystal face on one of the principal faces;
a (110) crystal face of the silicone substrate appears on the vertical face of the first opening; and
the specific crystal face appears on the end of the second layer side of the first opening is the (111) crystal face of the silicon substrate having a 55 degree angle relative to the one of principal face of the first layer.

4. The membrane structure according to claim 1, wherein the first layer comprising a silicon substrate having a (100) crystal face on one of the principal faces;
a (100) crystal face of the silicone substrate appears on the vertical face of the first opening; and
the specific crystal face appears on the end of the second layer side of the first opening is the (110) crystal face of the silicon substrate having a 45 degree angle relative to the one of principal face of the first layer.

5. The membrane structure according to claim 1, wherein the first layer comprising a silicon substrate having a (110) crystal face on the one of the principal faces;
a (111) crystal face of the silicone substrate appears on the vertical face of the first layer; and
the specific crystal face appears on the end of the second layer side of the first opening is the (111) crystal face of the silicon substrate having a 55 degree angle relative to the one of principal face of the first layer.

6. The membrane structure according to claim 1, wherein the first layer comprising a silicone substrate having a (111) crystal face as the one of principal face;
a (110) crystal face of the silicone substrate appears on the vertical face of the first opening;
the specific crystal face appears on an end of the second layer side of the first opening is the (110) crystal face of the silicone substrate having a 90 degree angle relative to the one of principal face of the first layer.

7. A manufacturing method of a membrane structure comprising the steps of;
forming a mask having an opening on a first layer of a substrate comprising at least the first layer, a second layer formed so as to cover one of principal faces of the first layer, and a third layer formed between the first and second layers;
forming a first opening having a side face in virtually vertical which passes through the first layer and by dry etching through the opening of the mask;
smoothing an inner peripheral face of the first opening of the first layer by wet etching such that a specific crystal face appears at least on an end of the second layer side of the first opening; and
forming a second opening on the third layer by etching through the opening of the first layer;
wherein the step of forming the second opening is to form the second opening such that an amount of setback of the opening of the second opening from the opening of the first layer at a boundary face of the first layer and the third layer is larger than 0, and about the same as the film thickness of the third layer or smaller than the film thickness; and
the steps of forming the first and second openings are to form the first and second opening so as to provide a predetermined deflection proximity to the opening depending on the difference in pressure applied to one principal face and another principal face.

8. The manufacturing method of membrane structure according to claim 7 wherein in a case when the first layer comprising a silicone substrate and the one of principal faces is a (100) crystal face;
the step for smoothing is to smooth an inner peripheral face of the first opening such that a (110) crystal face appears on a vertical face of the first opening; and
a (111) crystal face appears on an end of the second layer side of the first opening.

9. The manufacturing method of membrane structure according to claim 7 wherein in a case when the first layer comprising a silicone substrate and the one of principal faces is a (100) crystal face;
the step for smoothing is to smooth an inner peripheral face of the first opening such that a (100) crystal face appears on a vertical face of the first opening; and
a (110) crystal face appears on an end of the second layer side of the first opening.

10. The manufacturing method of membrane structure according to claim 7 wherein in a case when the first layer comprising a silicone substrate and the one of principal faces is a (110) crystal face;
the step for smoothing is to smooth an inner peripheral face of the first opening such that a (111) crystal face appears on a vertical face of the first opening; and
a (111) crystal face appears on an end of the second layer side of the first opening.

11. The manufacturing method of membrane structure according to claim 7 wherein in a case when the first layer comprising a silicone substrate and the one of principal faces is a (111) crystal face;
the step for smoothing is to smooth an inner peripheral face of the first opening such that a (110) crystal face appears on a vertical face of the first opening; and
a (110) crystal face appears on an end of the second layer side of the first opening.

12. The manufacturing method of membrane structure according to claim 7, wherein the smoothing process comprising an etching using alkali etchant or an organic solvent mixing alkali etchant.

13. The manufacturing method of membrane structure according to claim 12, wherein the alkali etchant is any one of KOH, TMAH, hydrazine, EDP, or NaOH; and
the organic solvent is an alcohol solvent.

14. (canceled)

15. (canceled)
